(19) United States
(12) Patent Application Publication
(10) Pub. No.: US 2026/0036190 A1
(43) Pub. Date: Feb. 5, 2026

(54) Rotor Assembly Deployment Mechanism With Cross-Linked Redundant Drive And Aircraft Using Same

(71) Applicant: Joby Aero, Inc., Santa Cruz, CA (US)

(72) Inventors: Robert Thodal, Santa Cruz, CA (US); Edward Stilson, Santa Cruz, CA (US); Baixi Pei, Newark, CA (US); Joachim Grenestedt, Reno, NV (US); Andrew Seth McClard, Santa Cruz, CA (US); Prachi Anand Tappu, Pune (IN); Pranjal Shiva, Santa Cruz, CA (US); Rex Tyler Ehman, Santa Cruz, CA (US)

(21) Appl. No.: 19/286,255

(22) Filed: Jul. 31, 2025

Related U.S. Application Data
(60) Provisional application No. 63/678,060, filed on Aug. 1, 2024.

(51) Int. Cl. F16H 21/40; B64C 27/52; B64C 29/00

(52) U.S. Cl. CPC F16H 21/40; B64C 27/52; B64C 29/00

(57) ABSTRACT

A rotor assembly deployment mechanism configured to deploy a rotor assembly of a vertical take-off and landing aircraft from a horizontal, forward thrust, position to a vertical, hover, position. The rotor assembly deployment mechanism is configured to deploy an electric motor and propeller together. The deployment mechanism uses redundant rotary actuators which are coupled together to provide redundant drive capability to the harmonic drives using internal cross-linking.

### CROSS-REFERENCE TO RELATED APPLICATIONS

This application claims priority to U.S. Provisional Patent Application No. 63/678,060 to Thodal et al., filed Aug. 1, 2024, which is hereby incorporated by reference in its entirety.

### FIELD OF THE INVENTION

This invention relates to the aviation field, namely a rotor assembly deployment mechanism used on aerial vehicles.

### BRIEF DESCRIPTION OF THE DRAWINGS

FIG. 1A is a vertical take-off and landing aircraft in a take-off configuration according to some embodiments of the present invention.

FIG. 1B is a vertical take-off and landing aircraft in a forward flight configuration according to some embodiments of the present invention.

FIG. 2 is a view of a nacelle and rotor according to some embodiments of the present invention.

FIGS. 3A-B are partial cutaway views of a nacelle, rotor, and

deployment mechanism.

FIGS. 4A-D are views of a rotor assembly deployment mechanism in a stowed configuration according to some embodiments of the present invention.

FIGS. 5A-E are views of a rotor assembly deployment mechanism in a partially deployed configuration according to some embodiments of the present invention.

FIGS. 6A-E are views of a rotor assembly deployment mechanism in a deployed configuration according to some embodiments of the present invention.

FIGS. 7A-E are views of a rotor assembly deployment mechanism in a fully deployed configuration according to some embodiments of the present invention.

FIGS. 8A-E are views of a rotor assembly deployment mechanism actuation sub-assembly according to some embodiments of the present invention.

FIG. 9 is a simplified cross-section of an actuation sub-assembly according to some embodiments invention.

FIGS. 10A-C are views of a control arm according to some embodiments of the present invention.

FIGS. 11A-C are views of a control link according to some embodiments of the present invention.

### SUMMARY

A rotor assembly deployment mechanism configured to deploy a rotor assembly of a vertical take-off and landing aircraft from a horizontal, forward thrust, position to a vertical, hover, position. The rotor assembly deployment mechanism is configured to deploy an electric motor and propeller together. The deployment mechanism uses redundant rotary actuators which are coupled together to provide redundant drive capability to the harmonic drives using internal cross-linking.

### DETAILED DESCRIPTION

In some embodiments of the present invention, a rotor assembly deployment mechanism provides a compact and reliable device adapted to control and alter the thrust angle of a rotor assembly of an aircraft. In some aspects, the rotor assembly deployment mechanism is configured to deploy an electric motor, a propeller hub, a propeller, and a spinner. In some aspects, the electric motor is outboard of the primary mounting plane of the rotor assembly mounting bracket of the rotor assembly deployment mechanism. In some aspects, the rotor assembly deployment mechanism utilizes redundant rotary actuators which are internally cross-linked to allow for the motor of a first rotary actuator to provide torque to drive a second rotary actuator in the case of a motor failure. In some aspects, the redundant rotary actuators have their output shafts facing each other in a co-axial configuration and share output bearings. In some aspect, the redundant rotary actuators are joined by a tubular structure which drives a single control link. In some aspects, the redundant rotary actuators are internally coupled by a cross-link shaft which traverses between the two rotary actuators within the tubular structure.

In some aspects, a representative aircraft propulsion system includes a rotor assembly, a nacelle, a propeller hub, and a drive motor with an external rotor. The rotor includes a propeller with a set of blades coupled to the propeller hub and may include a cowling, or spinner. The nacelle defines an outer surface. The drive motor includes a rotary portion rigidly coupled to the propeller hub, and a fixed portion coupled to the nacelle. The system can include a tilt mechanism housed at least partially in the lumen of the nacelle, a power supply, and any other suitable components. The aircraft propulsion system can be used in conjunction with a rotorcraft. The rotorcraft is preferably a tiltrotor aircraft with a plurality of aircraft propulsion systems (e.g., rotor assemblies, rotor systems, etc.), operable between a forward arrangement and a hover arrangement. However, the rotorcraft can alternatively be a fixed wing aircraft with one or more rotor assemblies, and/or any other suitable rotorcraft or vehicle propelled by rotors. The rotorcraft preferably includes an all-electric powertrain (e.g., battery powered electric motors) to drive the one or more rotor assemblies, but can additionally or alternatively include a hybrid powertrain (e.g., a gas-electric hybrid including an internal-combustion generator), an internal-combustion powertrain (e.g., including a gas-turbine engine, a turboprop engine, etc.), and any other suitable powertrain.

The term “rotor” as utilized herein, in relation to the aircraft propulsion system or otherwise, can refer to a rotor, a propeller, and/or any other suitable rotary aerodynamic actuator. While a rotor can refer to a rotary aerodynamic actuator that makes use of an articulated or semi-rigid hub (e.g., wherein the connection of the blades to the hub can be articulated, flexible, rigid, and/or otherwise connected), and a propeller can refer to a rotary aerodynamic actuator that makes use of a rigid hub (e.g., wherein the connection of the blades to the hub can be articulated, flexible, rigid, and/or otherwise connected), no such distinction is explicit or implied when used herein, and the usage of “rotor” can refer to either configuration, and any other suitable configuration of articulated or rigid blades, and/or any other suitable configuration of blade connections to a central member or hub. Likewise, the usage of “propeller” can refer to either configuration, and any other suitable configuration of articulated or rigid blades, and/or any other suitable configuration of blade connections to a central member or hub. Accordingly, the tiltrotor aircraft can be referred to as a tilt-propeller aircraft, a tilt-prop aircraft, and/or otherwise suitably referred to or described. The motor, which may be an electric motor, may also then have a motor rotor. It should be understood that the motor rotor represents a different usage of the term rotor than as discussed above with regard to a rotary aerodynamic actuator.

The rotor functions to rotate in a fluid under the power of the drive mechanism in order to provide thrust (e.g., to an attached aircraft). The rotor includes a set of blades coupled to a hub, and a cowling, or spinner, that at least partially encloses the hub. The set of blades functions to transfer the rotational momentum of the rotor to the fluid, resulting in at least a portion of the fluid having axial momentum (e.g., to provide thrust). The rotor can have any suitable number of blades; the rotor has five blades in an illustrative embodiment, but can alternatively have three blades, four blades, six blades, and any other suitable number of blades. In a specific example, the rotor includes five variable-pitch blades; in alternative examples, the rotor can have any suitable number of blades having variable- or fixed-pitch.

The rotor blades are preferably unconstrained at the blade tips (e.g., by any sort of physical structure), but the rotor can additionally or alternatively include a fairing that encloses the blade tips (e.g., such as the duct of a ducted fan). In such variations, the fairing can function to dampen the acoustic signature components (e.g., acoustic waves) that originate from the blade tips during rotation. However, the rotor blades can additionally or alternatively be constrained or unconstrained in any suitable manner.

The hub functions to mutually couple the set of blades and provide a region at which the rotor couples to the drive mechanism and receives rotary power therefrom. In some aspects, the motor is an outrunner electric motor, and the hub is structurally coupled to a forward surface of the rotor of the electric motor.

The lumen functions to define a volume that retains components of the aircraft propulsion system and/or other aircraft subsystems. Such retained components can include, in variations, at least a portion of a tilt mechanism, all or a portion of the power supply, power delivery subsystems (e.g., electrical power distribution cables, conduits, etc.), mechanical actuators (e.g., for actuating control surfaces of the aircraft), all or a portion of the drive mechanism, and any other suitable components.

In some aspects, an aerial vehicle may use bladed propellers powered by electric motors to provide thrust during take-off. The propeller/motor units may be referred to as rotor assemblies. In some aspects, the motor driven propeller units on the wings may themselves rotate relative to a fixed wing, such that the propellers provide vertical thrust for take-off and landing. The rotation of the motor driven propeller units may allow for directional change of thrust by rotating both the propeller and the electric motor, thus not requiring any gimbaling, or other method, of torque drive around or through a rotating joint.

In some aspects, aerial vehicles according to embodiments of the present invention take off from the ground with vertical thrust from rotor assemblies that have deployed into a vertical configuration. As the aerial vehicle begins to gain altitude, the rotor assemblies may begin to be tilted forward in order to begin forward acceleration. As the aerial vehicle gains forward speed, airflow over the wings results in lift, such that the rotors become unnecessary for maintaining altitude using vertical thrust. Once the aerial vehicle has reached sufficient forward speed, some or all of the blades used for providing vertical thrust during take-off may be stowed along their nacelles. In some aspects, all rotor assemblies used for vertical take-off and landing are also used during forward flight. The nacelle supporting the rotor assemblies may have recesses such that the blades may nest into the recesses, greatly reducing the drag of the disengaged rotor assemblies.

After take-off, the aerial vehicle will begin a transition to forward flight by articulating the rotors from a vertical thrust orientation to a position which includes a horizontal thrust element. As the aerial vehicle begins to move forward with speed, lift will be generated by the wings, thus requiring less vertical thrust form the rotors. As the rotors are articulated further towards the forward flight, horizontal thrust, configuration, the aerial vehicle gains more speed.

The electric motor/propeller combination being on the outboard side of the articulating joint allows for a rigid mounting of the propeller to the motor, which is maintained even as the propeller is moved through various attitudes relative to the rear nacelle portion. With such a configuration the rotating power from the motor need not be gimbaled or otherwise transferred across a rotating joint. The deployment is of the entire motor driven rotor assembly in some aspects. In some aspects, the deployment of the rotor assembly utilizes a linkage, which deploys the rotor assembly to a vertical thrust position while simultaneously pushing it forward and away from the remaining body of the nacelle. The push away from the remaining body of the nacelle reduces the download in the wing from the downwash of the associated rotor. In some aspects, the rotor assembly is both pushed forward and raised when deployed to a vertical thrust position from a horizontal thrust, stowed, position.

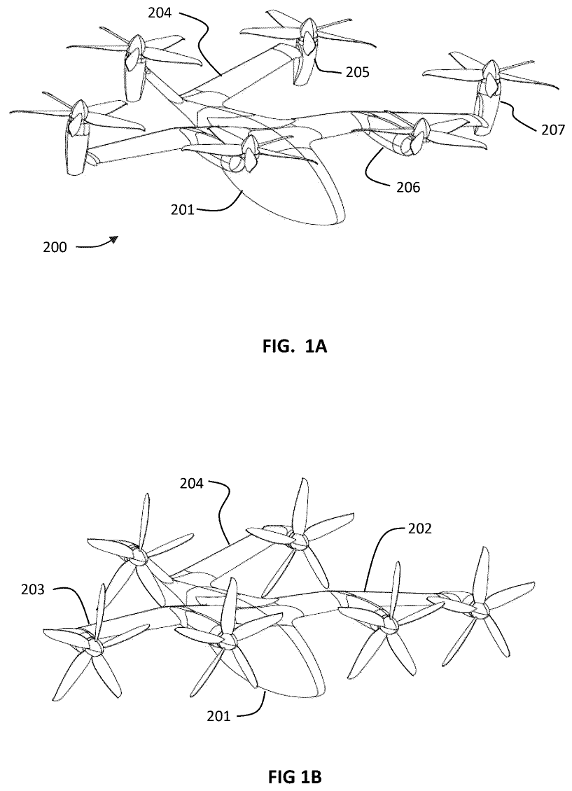

In a first configuration according to some embodiments of the present invention, as seen in a vertical take-off configuration in FIG. 1A, and a horizontal forward flight configuration in FIG. 1B, an aerial vehicle 200 uses fixed wings 202, 203, which may be forward swept or partially forward swept wings, with rotors of the same or different types adapted for both vertical take-off and landing and for forward flight. The aircraft body 201 supports a left wing 202 and a right wing 203. Motor driven rotor assemblies 206, 207 on the wings include propellers which may stow and nest into the nacelle body. In some embodiments, the propeller blades do not stow and nest into the nacelle body. The aircraft body 201 extends rearward is also attached to raised rear stabilizers 204. The rear stabilizers have rear rotor assemblies 205 attached thereto. Although two passenger seats are anticipated, other numbers of passengers may be accommodated in differing embodiments of the present invention. In some aspects, there may be five passenger seats. In some aspects, there may be a different number of passenger seats.

In some aspects, all or a portion of the wing mounted rotors may be adapted to be used in a forward flight configuration, while other wing mounted rotors may be adapted to be fully stowed during regular, forward, flight. The aerial vehicle 200 may have two rotors on the right wing 203 and two rotors on the left wing 202. The inboard rotor assemblies on each wing may have wing mounted rotors 206 that are adapted to flip up into a deployed position for vertical take-off and landing and to be moved back towards a stowed position during transition to forward flight. The outboard rotor assembly 207 may pivot in unison from a horizontal to a vertical thrust configuration.

Similarly, each rear stabilizer 204 may be have rotor units mounted to it, both of which are adapted to be used during vertical take-off and landing, and transition, modes. In some aspects, all of the rotor designs are the same, with a subset used with their main blades for forward flight. In some aspects, all of the rotor designs are the same, with all rotors used for forward flight. In some aspects, there may be a different number of rotor units mounted to the rear stabilizer 204.

In some embodiments, the electric motors of the aerial vehicle are powered by rechargeable batteries. The use of multiple batteries driving one or more power busses enhances reliability, in the case of a single battery failure. In some embodiments, the batteries may be spread out along the rotating portion, and there may be one battery for each of the motor/ducted fan assemblies. In some embodiments, the battery or batteries may reside in part or fully within the aircraft body, with power routed out to the motors through the rotational couplings. In some embodiments, the batteries reside within the vehicle body on a rack with adjustable position such that the vehicle balance may be adjusted depending upon the weight of the pilot. In some aspects, the aerial vehicle may be powered by fuel cells, which may be hydrogen fuel cells.

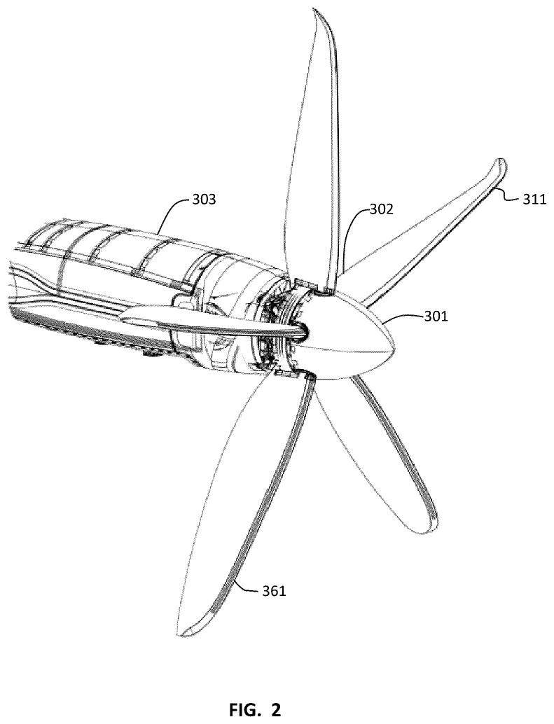

FIG. 2 illustrates, in partial view, a nacelle 303 which provides aerodynamic cover for support structure for a motor driven rotor assembly according to some embodiments of the present invention, which may be the mid-wing mounted rotor assembly 206. A spinner, or cowling, 301 is mounted forward of the rotor 302. The rotor assembly is coupled to the nacelle, or internal structure within the nacelle, through a rotor assembly deployment mechanism. A propeller 311 has blades 361 which are coupled to the propeller hub. The propeller hub is coupled to the motor rotor of the electric motor.

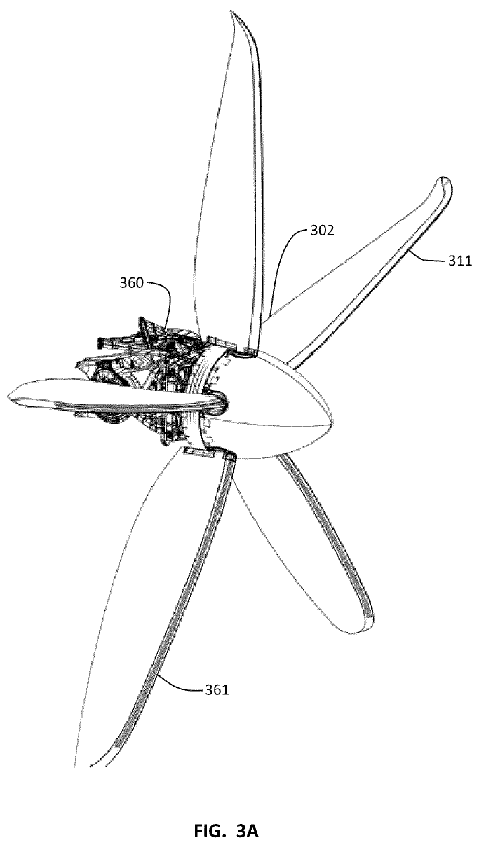

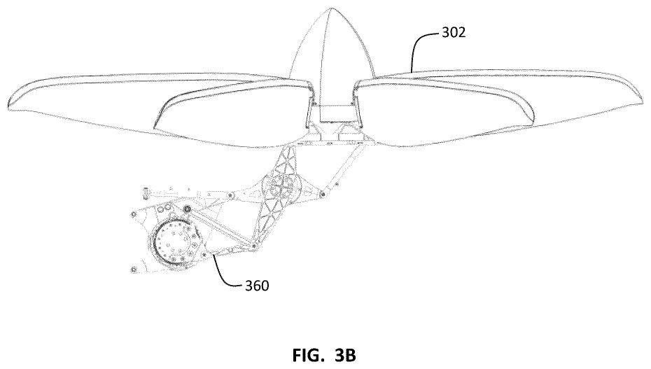

FIGS. 3A and 3B illustrate a rotor assembly deployment mechanism 360, removed from the aircraft and the nacelle for clarity of observation, in a stowed a and deployed configuration, respectively. The rotor 302 supports a propeller 361 with blades 311. In this illustrative embodiment, the propeller 361 has five blades 311. Although the rotor assembly deployment mechanism 360 differs from the rotor assembly deployment mechanism 100 discussed below, FIGS. 3A-B do illustrate the deployment positions. The deployment may result in the rotor both pushed forward and raised.

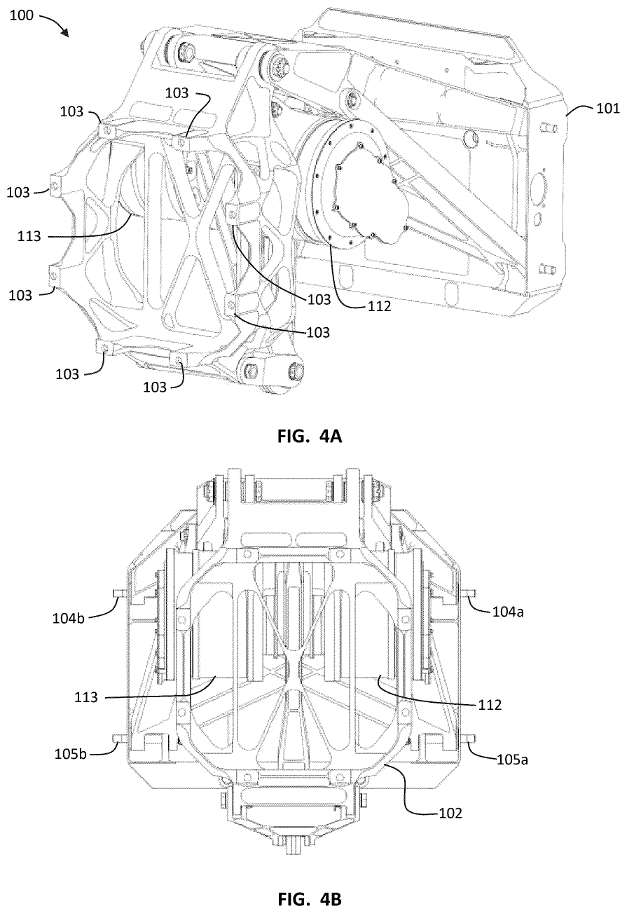

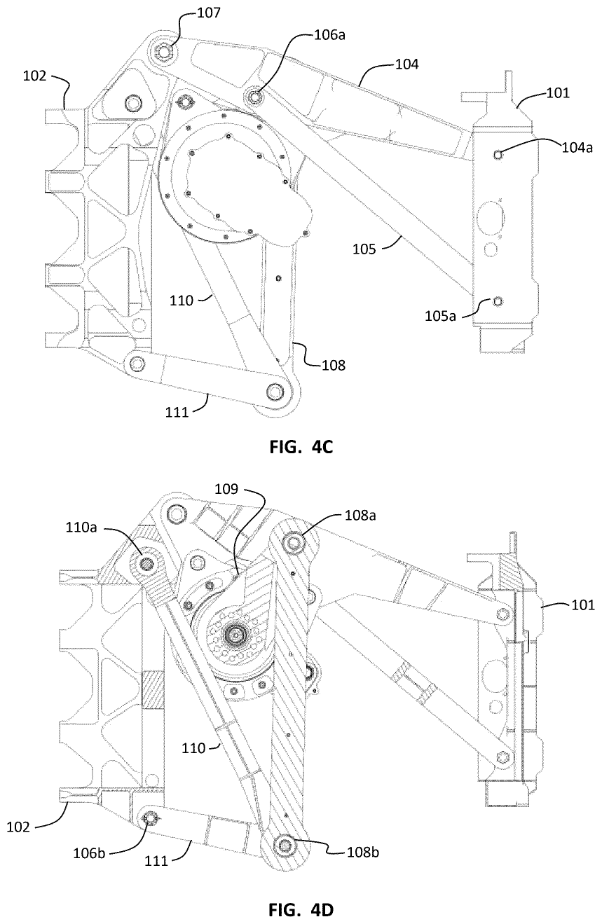

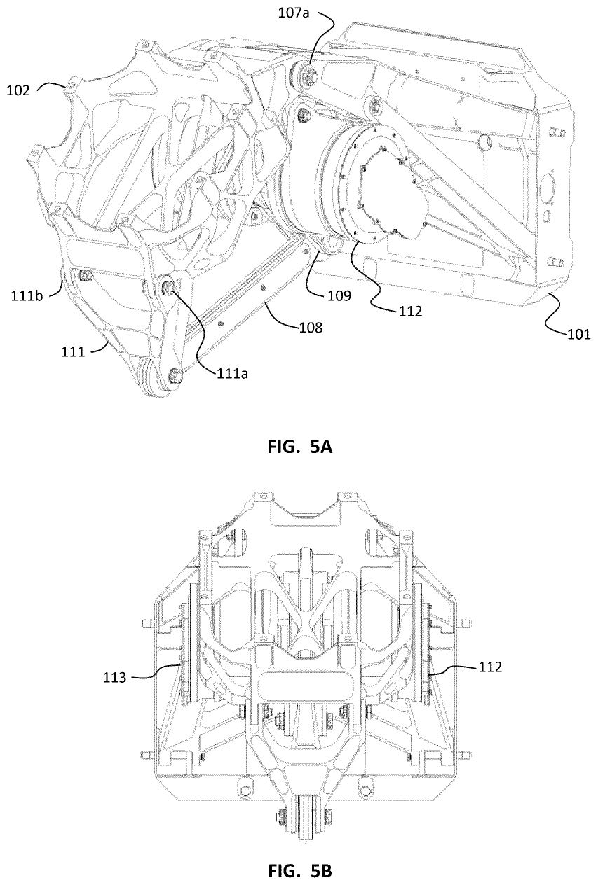

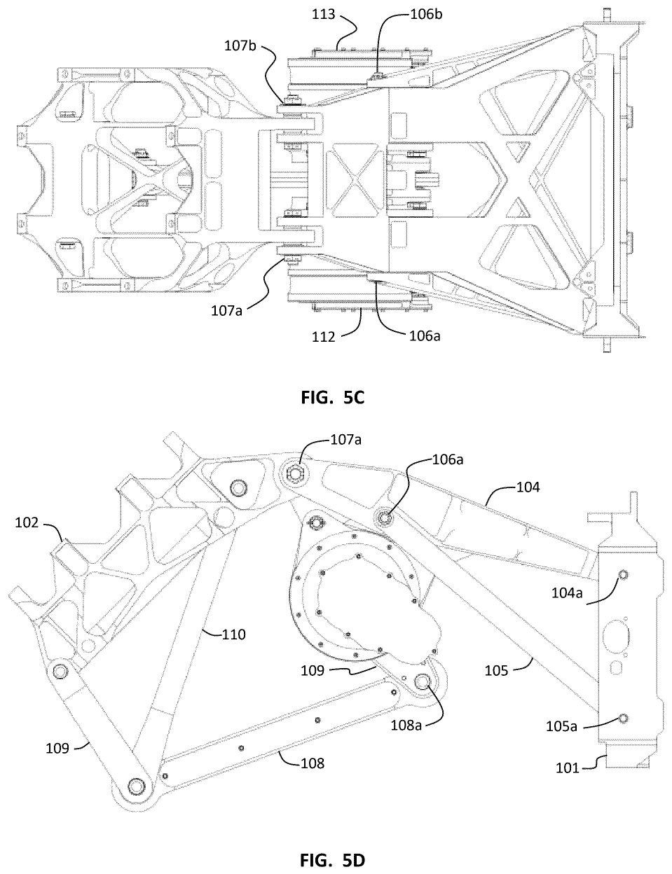

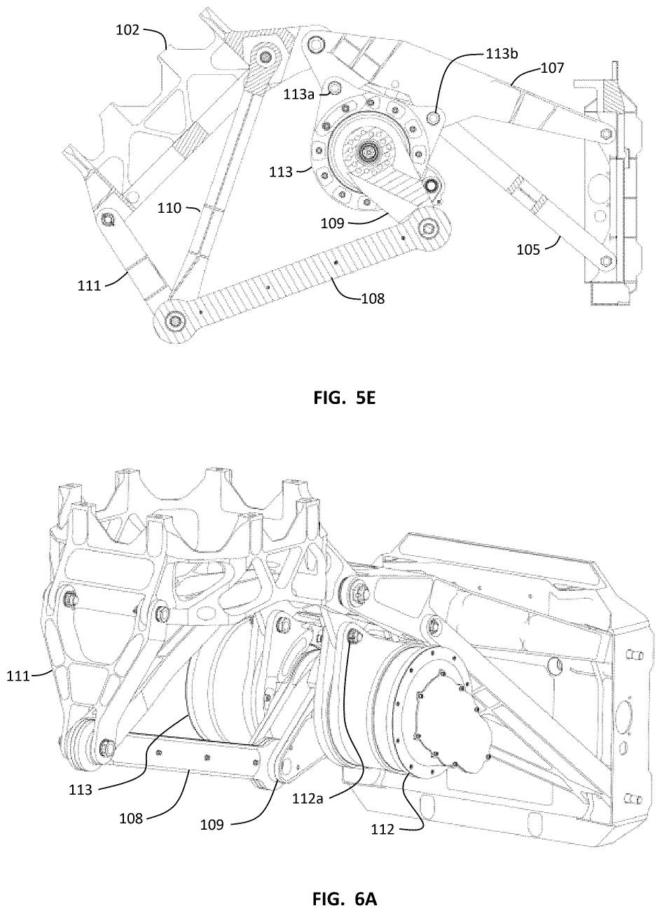

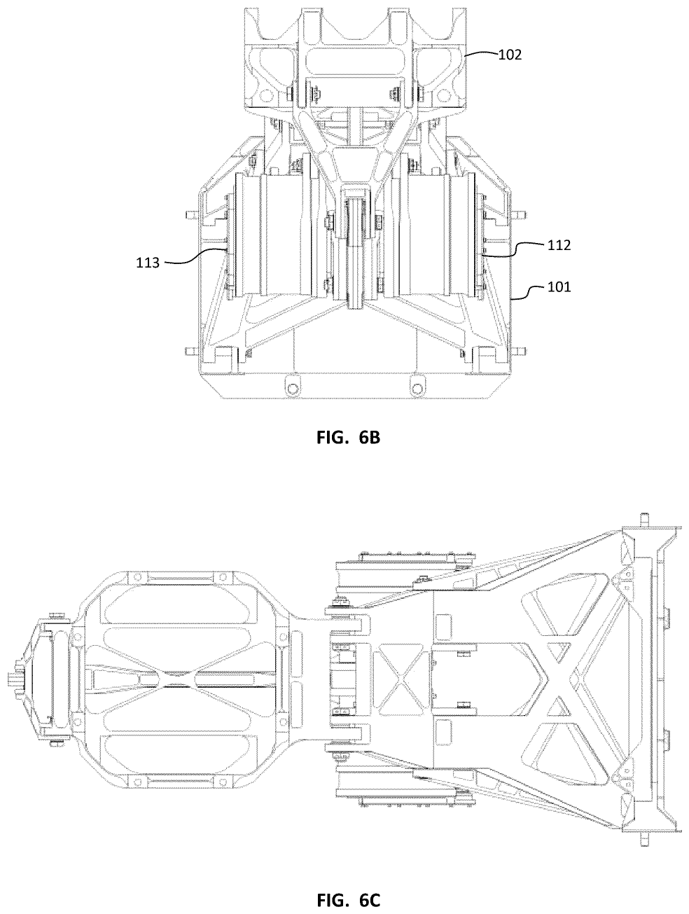

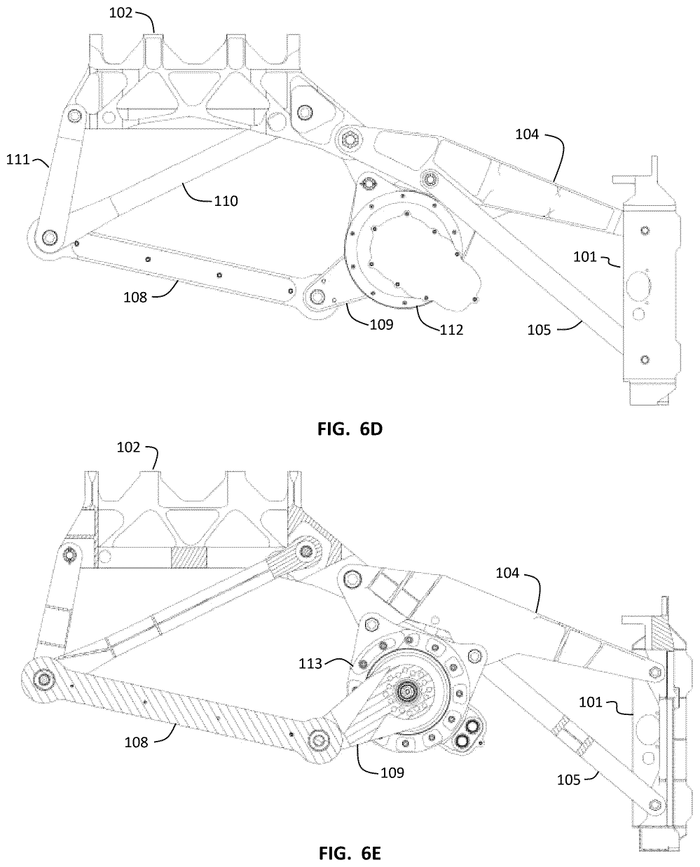

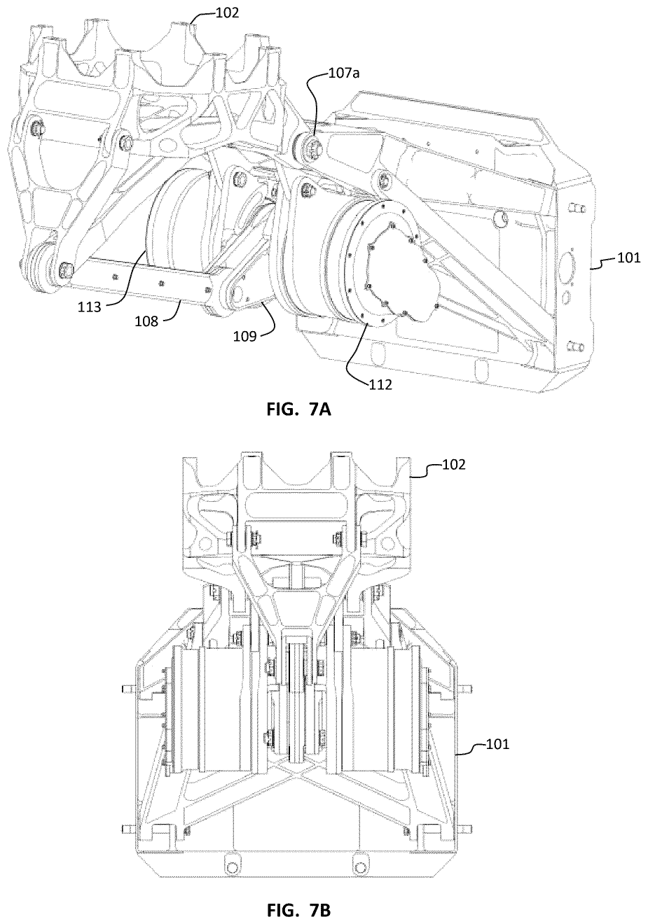

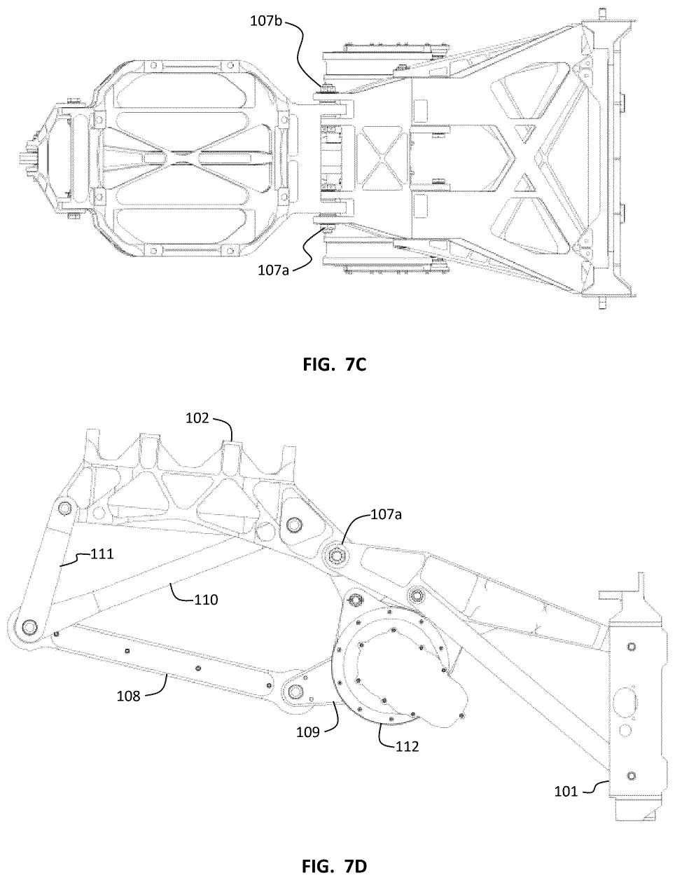

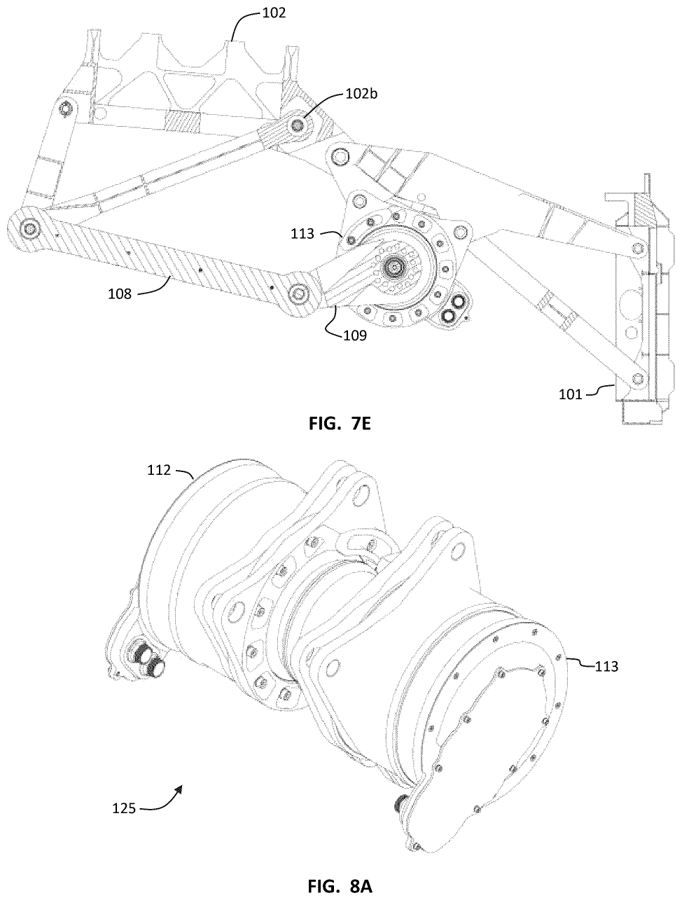

FIGS. 4A, 4B, 4C, and 4D illustrate a rotor assembly deployment mechanism 100 in a stowed configuration according to some embodiments of the present invention in a perspective front, a front, a side, and a cutaway view, respectively. FIGS. 5A, 5B, 5C, 5D, and 5E illustrate a rotor assembly deployment mechanism 100 in a partially deployed configuration according to some embodiments of the present invention in a perspective front, a front, a top, a side, and a cutaway view, respectively. FIGS. 6A, 6B, 6C, 6D, and 6E illustrate a rotor assembly deployment mechanism 100 in a 90 degree deployed configuration according to some embodiments of the present invention in a perspective front, a front, a top, a side view, and a cutaway view, respectively. FIGS. 7A, 7B, 7C, 7D, and 7E illustrate a rotor assembly deployment mechanism 100 in a fully deployed configuration according to some embodiments of the present invention in a perspective front, a front, a top, a side view, and a cutaway view, respectively. The rotor assembly deployment mechanism 100 is fixedly mounted into an aircraft with a main mounting bracket 101. The main mounting bracket 101 may have a plurality of mounting points which may facilitate coupling with fasteners to provide fixed structural attachments for the rotor assembly deployment mechanism 100. The main mounting bracket 101 may be coupled to structural attach points within the wing, and may be within the area covered by the outer surface of the nacelle. In an illustrative example, the rotor assembly deployment mechanism 100 may be used in conjunction with the mid-wing mounted motor driven rotor assemblies 206 as seen in FIG. 1A.

The outboard mounting bracket 102 provides structural support for the rotor assembly, and may have a plurality of attach points 103 on an outboard surface of the outboard mounting bracket 102. In some aspects, the mounting points 103 on the outboard surface of the outboard mounting bracket 102 may define a plane, which may be referred to as the mounting plane of the outboard mounting bracket 102. In some aspects, the outboard mounting bracket 102 forms a rigid outboard sub-structure with an upper outboard link 110 and a lower outboard link 111. The outboard mounting bracket 102, the upper outboard link 110, and the lower outboard link 111 thus deploy together in unison as an outboard sub-structure. The upper outboard link 110 may couple to the outboard mounting bracket at a joining point 110a. The lower outboard link 111 may coupled to the outboard mounting bracket 102 at two points 111a, 111b. A control link 108 provides the force to deploy the deployable outboard sub-structure. The upper outboard link 110 and lower outboard link 111 may be rotationally coupled to a distal end 108b of the control link 108. The proximal end 108a of the control link 108 is rotationally coupled to a drive link 109, which is coupled to the dual actuator deployment sub-assembly, as discussed further below.

In some aspects, the main mounting bracket 101 forms a rigid inboard sub-structure with an upper inboard link 104 and a lower inboard link 105. The main mounting bracket 101, the upper inboard link 104, and the lower inboard link 105 thus provide a stationary base from which the deployable portions of the deployment mechanism will deploy away from. The upper inboard link 104 may couple to the main mounting bracket at joining points 104a, 104b. The lower inboard link 105 may couple to the main mounting bracket 101 at joining points 105a, 105b. The lower inboard link 105 may couple to the upper inboard link at joining points 106a, 106b.

The outboard sub-structure, which includes the outboard mounting bracket 102, is able to be deployed relative to the inboard sub-structure, which includes the main mounting bracket 101. The outboard sub-structure is pivotally coupled to the inboard sub-structure with pivots 107a, 107b. In this illustrative example, the main pivots 107a, 107b pivotally couple the outboard mounting bracket 102 to the upper inboard link 104, which then pivotally couples the outboard sub-structure to the inboard sub-structure.

The rotor assembly deployment mechanism 100 deploys the outboard sub-structure relative to the inboard sub-structure using two rotary actuators 112, 113, which are coupled together to provide redundancy in an unusual fashion. The deployment is facilitated using a first rotary actuator 112 fixedly coupled to a first side of the upper inboard link 104 and a second rotary actuator 113 fixedly coupled to a second side of the upper inboard link 104. In some aspects, the rotary actuators may be otherwise coupled to the inboard sub-structure. In this illustrative example, the first rotary actuator 112 is coupled to the upper inboard link 104 at two coupling points 112a, 112b, and the second rotary actuator 113 is coupled to the upper inboard link 104 at two coupling points 113a, 113b.

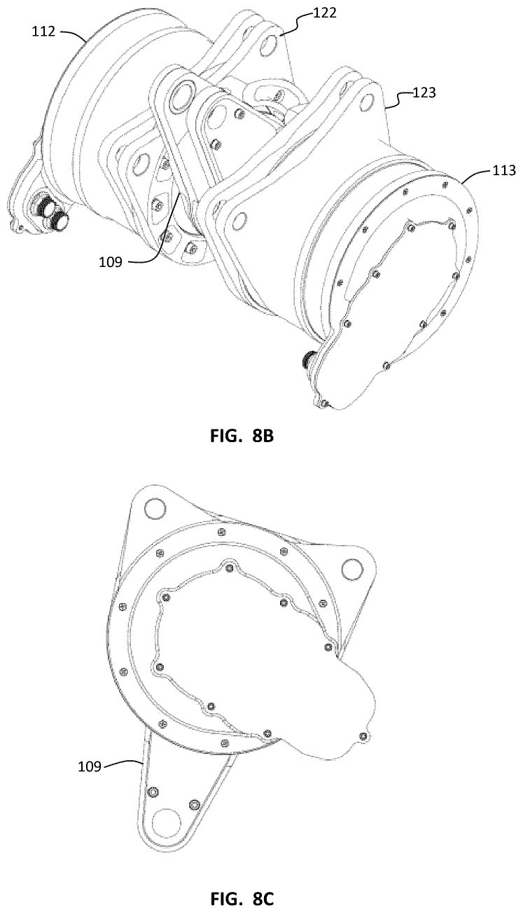

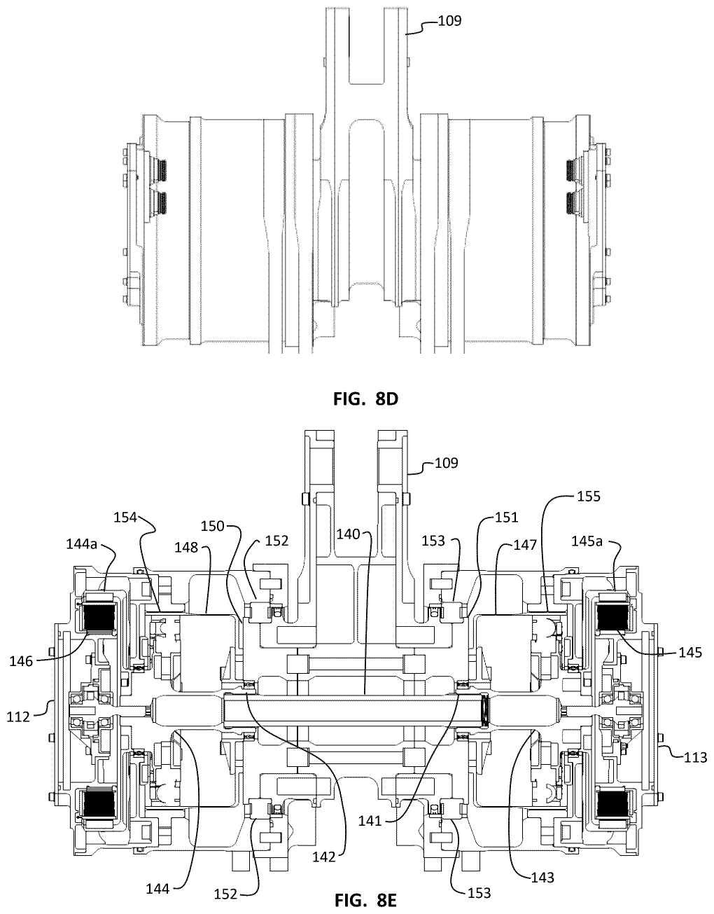

In some embodiments of the present invention, as seen in FIGS. 8A-E, a dual actuator deployment sub-assembly 125 links two rotary actuators 112, 113 to a single control arm 109. The rotation of the rotary actuators 112, 113 rotates the control arm 109, which in turn then drives the control link 108. The control link 108 then drives the outboard sub-structure around the main pivots 107a, 107b. The dual actuator sub-assembly 125 is fixedly coupled to the inboard sub-structure with a first attachment bracket 122 which is coupled to the first rotary actuator 112, and with a second attachment bracket 123 which is coupled to the second rotary actuator 113.

FIG. 8E is an illustrative cross-section of the dual actuator deployment sub-assembly 125 according to some embodiments of the present invention. A first rotary actuator 112 has a first motor, which may be a low profile outrunner motor. The stator 146 of the motor of the first rotary actuator 112 is rotationally coupled to the rotor 144a of the first motor and may be powered to provide rotational drive. The stator 146 of the motor of the first rotary actuator 112 is fixedly coupled to the inboard sub-structure. The first motor provides rotation of an input portion, or shaft, 144 configured to rotationally drive an elliptical wave generator which facilitates engagement 154 of a flexible gear, which may be part of a flexspline cup 148, to a rigid gear. The rotation of the motor rotor 144a thus has a motor output which rotates the input portion, which then provides rotational drive via the flexible gearing which then has the drive output to rotate the output bracket 150. The output bracket 150 is in turn structurally coupled to the drive link 109. The drive link 109 then drives the control link 108, providing deployment of the outboard sub-structure relative to the inboard sub-structure.

A second rotary actuator 113 has a first motor, which may be a low profile outrunner motor. The stator 145 of the motor of the second rotary actuator 113 is rotationally coupled to the rotor 145a of the second motor and may be powered to provide rotational drive. The stator 145 of the motor of the second rotary actuator 113 is fixedly coupled to the inboard sub-structure. The second motor provides rotation of an input portion 143 configured to rotationally drive an elliptical wave generator which facilitates engagement 155 of a flexible gear, which may be part of a flexspline cup 147, to a rigid gear. The rotation of the motor rotor 145a thus has a motor output which rotates the input portion, or shaft, 143, which then provides rotational drive via the flexible gearing to the drive output which rotates the output bracket 151. The output bracket 151 is in turn structurally coupled to the drive link 109. The drive link 109 then drives the control link 108, providing deployment of the outboard sub-structure relative to the inboard sub-structure.

It would be expected that the output brackets 150, 151 of the harmonic drives would each require stabilization to retain positional coherence during operation. At the very least, axial constraint around the output rotation axis would be provided. Typically, a bearing pair would be seen stabilizing the output shaft and/or bracket of a harmonic drive. In this example, there is output bracket/shaft stabilization for each of the rotary actuators 112, 113, but the pair of bearings 152, 153 is shared between the two actuators 112, 113. Thus, the same output bearing pair 152, 153 provides the positional stability for the output of the first rotary actuator 112, and for the second rotary actuator 113, and for the rotational support of the drive link 109.

In nominal operation, the first rotary actuator 112 and the second rotary actuator 113 would step, or otherwise rotate, in unison to facilitate deployment of the rotor assembly deployment mechanism 100. A redundant system with coaxial rotary actuators does provide redundant motors, such that it may continue to operate should one of the two harmonic drives have a failure which leads to loss of function one of their motors, whether a winding failure, an electrical power sub-system failure, or another type of failure. Yet this redundancy may not be effective, as a failed rotary actuator may present too much resistive torque to be able to be driven by the remaining actuator. The actuator design may present a very high detent, and may not be back-drivable via the output of the actuator. In some aspects, the failed actuator may be back-drivable but may have such high resistance that the remaining actuator may not have sufficient power to effectively drive the deployment mechanism.

However, in embodiments of present invention, the first rotary actuator 112 and the second rotary actuator 113 are internally cross-linked to address the back-drive limitation. A cross-link shaft 140 couples the input portion, or shaft, 144 of the first rotary actuator 112 to the input portion, or shaft, 143 of the second rotary actuator 113. The cross-link shaft 140 may be coupled to the input portion, or shaft, 144 of the first rotary actuator 112 with a splined interface 142. The cross-link shaft 140 may be coupled to the input portion, or shaft, 143 of the second rotary actuator 113 with a splined interface 141. The cross-link shaft 140 may pass through a hole in the drive link 109.

With the use of the cross-link shaft, a motor failure which results in loss of drive from one motor, and its associated rotary actuator, will not require the other rotary actuator to back-drive the other motor through its output bracketry. Instead, the cross-link shaft allows the healthy motor to provide torque to the input portion of the other motor, upstream from that rotary actuator's flexspline interface, and upstream from that rotary actuator's final output. In this scenario, a single functioning motor may drive the output of both rotary actuators.

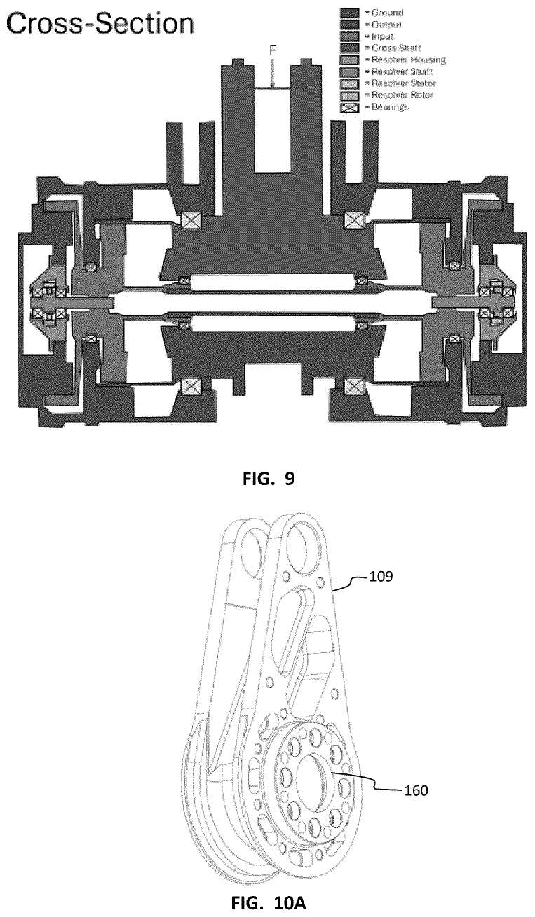

FIG. 9 further illustrates the cross-linked of the dual actuator deployment sub-assembly 125 of the rotor assembly deployment mechanism 100 according to some embodiments of the present invention. The support of the outputs of both rotary actuators by a single bearing pair, which also provides the rotational support for the drive link, is seen in a somewhat simplified representation. Also, the cross-linking of the two actuators with a cross-link shaft is represented.

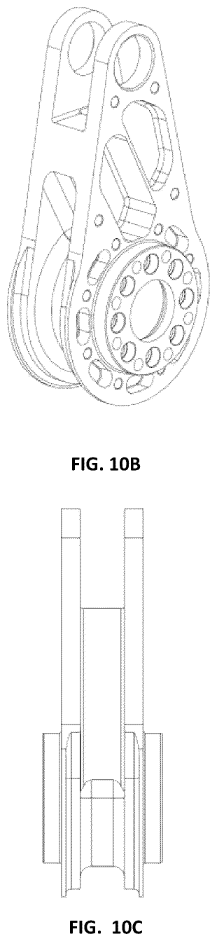

FIGS. 10A-C illustrate a drive link 109 according to some embodiments of the present invention. The drive link 109 is coupled to and embedded within the dual actuator deployment sub-assembly 125 of the rotor assembly deployment mechanism 100 on a first end and pivotally coupled to the control link 108 on a second end. The drive link 109 may have a hole 160 through which the cross-link shaft 140 may pass through in the assembled unit. The hole 160 may be co-axial with the cross-link shaft 140 and the first rotary actuator 112 and a second rotary actuator 113.

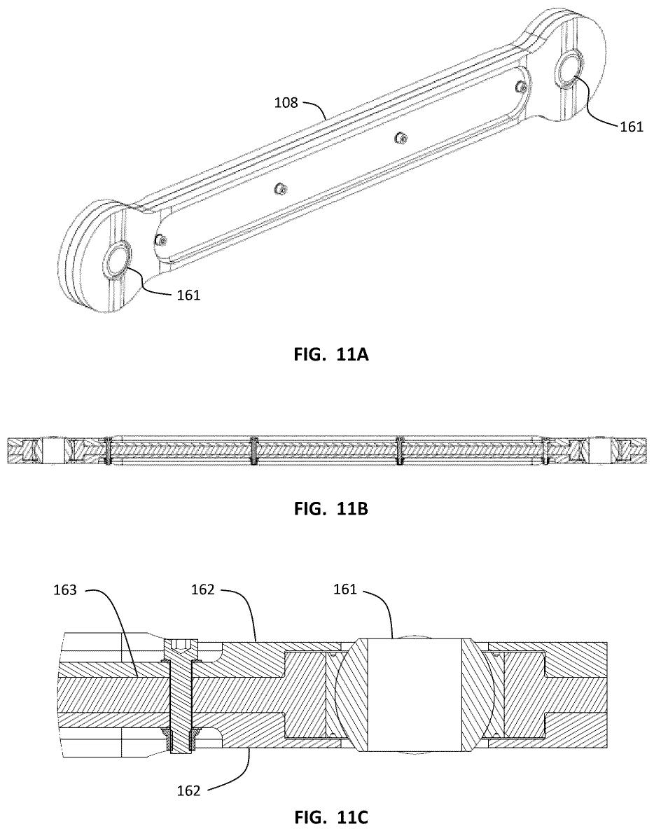

FIGS. 11A-C illustrate a control link 108 according to some embodiments of the present invention. In some aspects, the drive link 108 has spherical bearings at each end. In some aspects, the control link 108 may be constructed in a laminate fashion, which may allow the outer sheets to capture the outer race of the spherical bearings. Outer sheets 162 may capture an inner sheet 163, and then also capture bearings 161.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A redundant deployment mechanism, said redundant deployment mechanism comprising:
an inboard sub-structure;
an outboard sub-structure, said outboard substructure pivotally coupled to said inboard sub-structure; and
a dual actuator deployment sub-assembly, said dual actuator deployment sub-assembly rigidly coupled to said inboard sub-structure, said dual actuator deployment substructure comprising:
a drive link;
a first rotary actuator, said first rotary actuator having a principal axis, a drive output of said first rotary actuator fixedly coupled to said drive link on a first side of said drive link;
a second rotary actuator, said second rotary actuator having a principal axis, a drive output of said second rotary actuator fixedly coupled to said drive link on a second side of said drive link; and
a cross-link shaft, said cross-link shaft coupled a motor output of said first rotary actuator on a first end, said cross-link shaft coupled to a motor output of said second rotary actuator on a second end.

2. The redundant deployment mechanism of claim 1 wherein said principal axis of said first rotary actuator and said principal axis of said second rotary actuator are co-axial.

3. The redundant deployment mechanism of claim 1 wherein said inboard sub-structure has a first side and a second side, and wherein said first rotary actuator is coupled to said first side of said inboard sub-structure, and wherein said second rotary actuator is coupled to said second side of said inboard sub-structure.

4. The redundant deployment mechanism of claim 2 wherein said inboard sub-structure has a first side and a second side, and wherein said first rotary actuator is coupled to said first side of said inboard sub-structure, and wherein said second rotary actuator is coupled to said second side of said inboard sub-structure.

5. The redundant deployment mechanism of claim 3 wherein said drive link resides between said first rotary actuator and said second rotary actuator.

6. The redundant deployment mechanism of claim 4 wherein said drive link resides between said first rotary actuator and said second rotary actuator.

7. The redundant deployment mechanism of claim 5 wherein said cross-link shaft couples the motor output of said first rotary actuator to the motor output of said second rotary actuator through a hole in said drive link.

8. The redundant deployment mechanism of claim 6 wherein said cross-link shaft couples the motor output of said first rotary actuator to the motor output of said second rotary actuator through a hole in said drive link.

9. The redundant deployment mechanism of claim 1 further comprising a control link, said control link pivotally coupled to said outboard sub-structure on a first end, said control link pivotally coupled to said drive link on a second end.

10. The redundant deployment mechanism of claim 7 further comprising a control link, said control link pivotally coupled to said outboard sub-structure on a first end, said control link pivotally coupled to said drive link on a second end.

11. The redundant deployment mechanism of claim 8 further comprising a control link, said control link pivotally coupled to said outboard sub-structure on a first end, said control link pivotally coupled to said drive link on a second end.

12. The redundant deployment mechanism of claim 10 wherein the drive output of said first rotary actuator is rotationally coupled to said inboard sub-structure with a first output bearing, and wherein the drive output of said second rotary actuator is rotationally coupled to said inboard sub-structure with a second output bearing, said first output bearing and said second output bearing thereby forming an output bearing pair.

13. The redundant deployment mechanism of claim 12 wherein said first output bearing and said second output bearing are the only bearings directly supporting to rotation between said drive link and said inboard sub-structure.

14. The redundant deployment mechanism of claim 11 wherein the drive output of said first rotary actuator is rotationally coupled to said inboard sub-structure with a first output bearing, and wherein the drive output of said second rotary actuator is rotationally coupled to said inboard sub-structure with a second output bearing, said first output bearing and said second output bearing thereby forming an output bearing pair.

15. The redundant deployment mechanism of claim 14 wherein said first output bearing and said second output bearing are the only bearings directly supporting to rotation between said drive link and said inboard sub-structure.

16. The redundant deployment mechanism of claim 13 wherein said first rotary actuator comprises a position sensor, and wherein said second position sensor comprises a position sensor.

17. The redundant deployment mechanism of claim 15 wherein said first rotary actuator comprises a position sensor, and wherein said second position sensor comprises a position sensor.

18. The redundant deployment mechanism of claim 9 wherein said control link is pivotally coupled to said outboard sub-structure with a spherical bearing, and wherein said control link is pivotally coupled to said drive link with a spherical bearing.

19. The redundant deployment mechanism of claim 10 wherein said control link is pivotally coupled to said outboard sub-structure with a spherical bearing, and wherein said control link is pivotally coupled to said drive link with a spherical bearing.
